(19) United States
(12) Patent Application Publication
(10) Pub. No.: US 2004/0165084 A1
(43) Pub. Date: Aug. 26, 2004

(54) Flicker detecting method and flicker detecting apparatus

(75) Inventors: Shinji Yamamoto, Osaka (JP); Toshiyuki Nakashima, Osaka (JP); Katsumi Tokuyama, Osaka (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/732,860

(22) Filed: Dec. 11, 2003

(30) Foreign Application Priority Data
Feb. 26, 2003 (JP) P. 2003-049234

(51) Int. Cl. H04N 9/73

(52) U.S. Cl. 348/226.1

(57) ABSTRACT

A flicker detecting apparatus has integrating means for integrating a pixel level every line in one frame or one field of a video to calculate a line lightness value, extracting means for extracting a fluctuation cycle in a vertical scanning direction of the line lightness value, and deciding means for deciding that a flicker is present when the fluctuation cycle is within a predetermined frequency range. The extracting means calculates a difference made by a fluctuation in the vertical scanning direction of the line lightness value every line, counts the number of continuations of an identical code in the difference, and calculates the count value as fluctuation cycle.

The present application is based on Japanese Patent Applications No. 2003-049234, which is incorporated herein by reference.

### BACKGROUND OF THE INVENTION

1. Field of the Invention

The present invention relates to a flicker detecting method and apparatus for detecting a flicker generated on a video picked up by using a solid-state imaging unit under an illuminated light in which a brightness fluctuates at a power frequency.

2. Description of the Related Art

In some cases in which a video is picked up by using the solid-state imaging unit under the illuminated light in which a brightness fluctuates at a power frequency, a flicker is generated so that a luminance level fluctuates on a screen or a moving striped pattern is recognized because the lighting cycle of the illuminated light is not synchronized with the scanning cycle of the solid-state imaging unit. For this reason, conventionally, there has been taken a countermeasure for detecting a flicker generated on a video picked up and correcting the video (for example, see Patent Document 1).

An MOS type imaging unit sequentially reads an exposed video on a line unit. An illuminated light fluctuates at a double of a power frequency. In the case in which a frame rate is not synchronized with the same frequency, therefore, an amount of exposure for each line fluctuates so that a flicker is generated. As a countermeasure, the shutter speed of the exposure is set to be adapted to a flicker cycle. Consequently, the amount of the exposure for each line is constant so that the flicker can be suppressed.

In order to take the countermeasure, first of all, it is necessary to detect the generation of a flicker. FIG. 11 is a diagram for explaining a principle of generating a signal obtained by removing a flicker component from a video signal in a conventional flicker detecting method. In the case in which an illuminated light has a power frequency of 50 Hz and a frame rate of 30 Hz in FIG. 11, the amount of exposure for each line is equalized by integrating a video signal corresponding to three frames from a video picked up by using the MOS type imaging unit. Therefore, it is shown that the flicker component is removed.

FIG. 10 is a block diagram showing the structure of a conventional flicker detecting apparatus. In FIG. 10, the flicker detecting apparatus comprises integrating means 101, storage means 102 for inputting the output of the integrating means 101, averaging means 103 for inputting the output of the integrating means 101 and the output of the storage means 102, static portion extracting means 104 for inputting the output of the integrating means 101, dividing means 105 for inputting the output of the integrating means 101, the output of the averaging means 103 and the output of the static portion extracting means 104, and flicker deciding means 106 for inputting the output of the dividing means 105.

A video signal for an effective scanning period which is picked up by the MOS type imaging unit (not shown) is input to the integrating means 101. The integrating means 101 integrates or averages, for each line, the pixel level of a video signal for an effective scanning period in one frame, and outputs a line lightness value.

The storage means 102 temporarily stores line lightness values corresponding to predetermined number of frames which are output from the integrating means 101. The averaging means 103 adds or averages, for each line, line lightness values corresponding to the predetermined number of frames which are stored in the storage means 102, thereby outputting the line lightness value from which a flicker component is removed.

FIG. 12 is a diagram for explaining a method of generating line lightness values obtained by removing the flicker component from the line lightness values corresponding to three frames. When a line lightness value for a j-th line in an n-th frame is represented by SUMnj, a line lightness value AVEnj from which the flicker component is removed is calculated in the following equation.

AVEnj=(SUMn−1j+SUMn−2j+SUMn−3j)/3

The static portion extracting means 104 extracts the static portion of an image by using the output of the integrating means 101. The static portion extracting means 104 includes an adding section 107 for inputting the output of the integrating means 101, a storage section 108 for inputting the output of the adding section 107, and a static portion extracting section 109 for inputting the output of the adding section 107 and the output of the storage section 108.

In the static portion extracting means 104, the adding section 107 adds the line lightness value output from the integrating means 101 for lines corresponding to N cycles (N is 1 or more) of a flicker cycle in the frame. The result of the addition includes an identical cycle change component for the cycle change of an illuminated light in any frame. Therefore, it is possible to consider that a change in the result of the addition between the frames corresponds to a variation in an object.

The storage section 108 temporarily stores the output of the adding section 107. The static portion extracting section 109 calculates a difference between the result of the addition output from the adding section 107 and the result of an addition obtained one frame before which is read from the storage section 108, and decides that the line portion corresponding to the N cycles is a static portion if the difference is equal to or smaller than a predetermined threshold.

The dividing means 105 divides the line lightness value SUMnj to be the output of the integrating means 101 by the line lightness value AVEnj obtained by removing the flicker component to be the output of the averaging means 103, thereby calculating a flicker component value SUMnj/AVEnj for each line in the line portion corresponding to the N cycles which is decided to be the static portion by the static portion extracting means 104.

FIG. 13 is a block diagram showing the structure of the flicker deciding means 106. The flicker deciding means 106 carries out the discrete Fourier transform over the flicker component value SUMnj/AVEnj for each line which is output from the dividing means 105, thereby calculating a frequency component of 50 Hz or 60 Hz of the flicker component value, and certifies the frequency component based on a threshold, thereby deciding the presence of a flicker.

[Patent Document 1]

Unexamined Japanese Patent Publication No. 2001-119708

The related art has such an advantage that the static portion of an object is extracted to detect a flicker so that a flicker in a frame generated during imaging using an MOS type imaging unit can be detected also when a luminance level fluctuates due to the movement of the object.

However, the integrated value of video signals in a plurality of frames is used for calculating a line lightness value from which a flicker component is removed and extracting the static portion of the object. Therefore, there is a problem in that a long processing time is taken for detecting a flicker, and furthermore, the static portion of the object is hard to extract when the object is moving.

In the case in which an illuminated light has a power frequency of 60 Hz and a frame rate of 30 Hz or the case in which the illuminated light has a power frequency of 50 Hz and a frame rate of 25 Hz, moreover, a striped pattern to move over a screen appears when the power frequency fluctuates. A line lightness value for each line between the frames is not changed. Therefore, a method of averaging the video signals in the frames has a problem in that it is hard to extract the video signal from which the flicker component is removed.

Furthermore, a frequency component is detected by using the discrete Fourier transform in the decision of the presence of a flicker. Therefore, there is a problem in that a circuit scale for carrying out the discrete Fourier transform processing is increased. There is a problem in that a circuit scale is increased also in the case in which a conversion table stored in an ROM is to be used as a countermeasure, and the countermeasure cannot be taken when the frame rate is changed.

### SUMMARY OF THE INVENTION

The invention has been made to solve the conventional problems and has an object to provide a flicker detecting method and apparatus capable of detecting a flicker also when a frame rate and a power frequency of an illuminated light have a proportional relationship without the influence of the movement of an object.

A first aspect of the invention is directed to a flicker detecting method of integrating a pixel level every line in one frame or one field of a video to calculate a line lightness value, extracting a fluctuation cycle in a vertical scanning direction of the line lightness value, and deciding that a flicker is present when the fluctuation cycle is within a predetermined frequency range.

According to the structure, the fluctuation cycle in the vertical scanning direction of the line lightness value is extracted and decided. Consequently, a flicker cycle information can be extracted from a video signal in one frame. Therefore, it is possible to detect a flicker without the influence of the movement of an object, and furthermore, to detect a flicker also when a frame rate and a power frequency of an illuminated light have a proportional relationship.

A second aspect of the invention is directed to the flicker detecting method according to the first aspect of the invention, wherein the line lightness value is calculated every plural blocks in one frame or one field of the video, the fluctuation cycle is extracted in the blocks, and a flicker is decided to be present when the fluctuation cycle is within a predetermined frequency range in a predetermined number of blocks.

According to the structure, one frame or one field of the video is divided into a plurality of blocks to extract the fluctuation cycle. Consequently, it is possible to increase a possibility that the flicker cycle information might be extracted from the block having a small change in a luminance level which is more suitable for the detection of the flicker. Consequently, it is possible to make a decision with higher precision.

A third aspect of the invention is directed to the flicker detecting method according to the first or second aspect of the invention, wherein a difference made by a fluctuation in the vertical scanning direction of the line lightness value is calculated every line, the number of continuations of an identical code in the difference is counted, and the count value of the number of continuations of the identical code is set to be a value representing the fluctuation cycle and is thus compared with the predetermined frequency range.

According to the structure, by a method of counting the number of continuations of a difference code by the fluctuation in the line lightness value, it is not necessary to use the conventional discrete Fourier transform. Consequently, it is possible to reduce a circuit scale required for a flicker detecting process.

A fourth aspect of the invention is directed to a flicker detecting method comprising the steps of integrating a pixel level every line in one frame or one field of a video to calculate a line lightness value, extracting a fluctuation cycle in a vertical scanning direction of the line lightness value, and deciding that a flicker is present when the fluctuation cycle is within a predetermined frequency range.

According to the structure, the fluctuation cycle in the vertical scanning direction of the line lightness value is extracted and decided. Consequently, a flicker cycle information can be extracted from a video signal in one frame. Thus, it is possible to detect a flicker without the influence of the movement of an object, and furthermore, to detect a flicker also when a frame rate and a power frequency of an illuminated light have a proportional relationship.

A fifth aspect of the invention is directed to the flicker detecting method according to the fourth aspect of the invention, further comprising the steps of integrating a pixel level every line for each of a plurality of blocks in one frame or one field of the video to calculate the line lightness value, and deciding that a flicker is present when the fluctuation cycle in a predetermined number of blocks is within the predetermined frequency range.

According to the structure, one frame or one field of a video is divided into a plurality of blocks to extract the fluctuation cycle. Consequently, it is possible to increase a possibility that the flicker cycle information might be extracted from the block having a small change in a luminance level which is more suitable for the flicker in the video signal for one frame. Consequently, it is possible to make a decision with higher precision.

A sixth aspect of the invention is directed to the flicker detecting method according to the fourth or fifth aspect of the invention, further comprising the steps of calculating a difference made by a fluctuation in the vertical scanning direction of the line lightness value every line, counting the number of continuations of an identical code in the difference, and comparing a count value of the number of continuations of the identical code to be the fluctuation cycle with the predetermined frequency range.

According to the structure, by a method of counting the number of continuations of a difference code by the fluctuation in the line lightness value, it is not necessary to use the conventional discrete Fourier transform. Consequently, it is possible to reduce a circuit scale required for a flicker detecting process.

A seventh aspect of the invention is directed to a flicker detecting apparatus comprising integrating means for integrating a pixel level every line in one frame or one field of a video to calculate a line lightness value, extracting means for extracting a fluctuation cycle in a vertical scanning direction of the line lightness value, and deciding means for deciding that a flicker is present when the fluctuation cycle is within a predetermined frequency range.

According to the structure, the fluctuation cycle in the vertical scanning direction of the line lightness value is extracted and decided. Consequently, a flicker cycle information can be extracted from a video signal in one frame. Thus, it is possible to detect a flicker without the influence of the movement of an object, and furthermore, to detect a flicker also when a frame rate and a power frequency of an illuminated light have a proportional relationship.

An eighth aspect of the invention is directed to the flicker detecting apparatus according to the seventh aspect of the invention, wherein the integrating means integrates a pixel level every line in each of blocks obtained by a division of one frame or one field of the video, thereby calculating a line lightness value, the extracting means extracts the fluctuation cycle in the vertical scanning direction of the line lightness value every block, and the deciding means decides that a flicker is present when the fluctuation cycle is within a predetermined frequency range in a predetermined number of blocks.

According to the structure, one frame or one field of a video is divided into a plurality of blocks to extract the fluctuation cycle. Consequently, it is possible to increase a possibility that the flicker cycle information might be extracted from the block having a small change in a luminance level which is more suitable for the detection of the flicker in the video signal for one frame. Thus, it is possible to make a decision with higher precision.

A ninth aspect of the invention is directed to the flicker detecting apparatus according to the seventh or eighth aspect of the invention, wherein the extracting means includes difference calculating means for calculating a difference made by a fluctuation in the vertical scanning direction of the line lightness value every line, count means for counting the number of continuations of an identical code in the difference, and deciding means for deciding the fluctuation cycle based on a count value of the number of continuations of the identical code.

According to the structure, by a method of counting the number of continuations of a difference code depending on the fluctuation in the line lightness value, it is not necessary to use the conventional discrete Fourier transform. Consequently, it is possible to reduce a circuit scale required for a flicker detecting process.

### BRIEF DESCRIPTION OF THE DRAWINGS

In the accompanying drawings:

FIG. 1 is a block diagram showing the structure of a flicker detecting apparatus according to a first embodiment of the invention;

FIG. 2 is a block diagram showing flicker extracting means according to the first embodiment of the invention;

FIG. 3 is a diagram for explaining a method of integrating a pixel level for each line to obtain a line lightness value,

FIG. 4 is a diagram for explaining a method of obtaining a difference code for each line;

FIG. 5 is a diagram for explaining a method of extracting a fluctuation cycle information about a line lightness value from the count value of the difference code;

FIG. 6 is a block diagram showing the structure of a flicker detecting apparatus according to a second embodiment of the invention;

FIG. 7 is a diagram showing an example of a block division according to the second embodiment of the invention;

FIGS. 8A and 8B are diagrams for explaining the advantage of the second embodiment of the invention as compared with the first embodiment;

FIG. 9 is a flow chart showing a processing procedure for a flicker detecting method according to the second embodiment of the invention;

FIG. 10 is a block diagram showing a conventional flicker detecting apparatus;

FIG. 11 is a diagram for explaining a principle of generating a signal obtained by removing a flicker component from a video signal in a conventional flicker detecting method;

FIG. 12 is a diagram for explaining a method of generating a line lightness value obtained by removing a flicker component from a line lightness value corresponding to three frames in the conventional flicker detecting method; and

FIG. 13 is a block diagram showing flicker deciding means in the conventional flicker detecting apparatus.

### DETAILED DESCRIPTION OF THE PREFERRED EMBODIMENTS

An embodiment of the invention will be described below with reference to the drawings.

(First Embodiment)

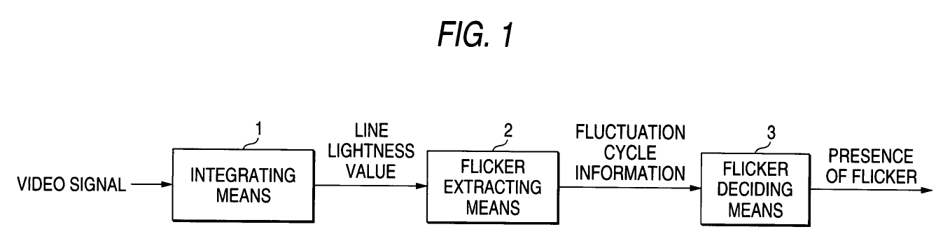

FIG. 1 is a block diagram showing the structure of a licker detecting apparatus according to a first embodiment of the invention. In FIG. 1, the flicker detecting apparatus comprises integrating means 1, flicker extracting means 2 and flicker deciding means 3.

A video signal for an effective scanning period which is picked up by an MOS type imaging unit (not shown) is input to the integrating means 1. The integrating means 1 integrates or averages, for each line, the pixel level of a video signal for the effective scanning period in one frame, thereby outputting a line lightness value.

The flicker extracting means 2 stores a line lightness value output from the integrating means 1, and extracts a fluctuation cycle information about the line lightness value from a series of line lightness values in one frame. The flicker deciding means 3 compares the fluctuation cycle information about the line lightness value extracted from the flicker extracting means 2 with a frequency deciding information and decides that a flicker is present within a predetermined frequency range.

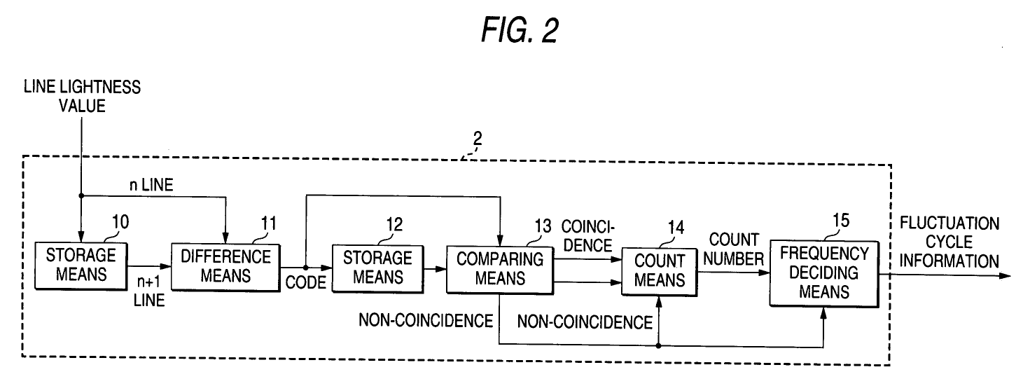

FIG. 2 is a block diagram showing the flicker extracting means 2 in the flicker detecting apparatus according to the embodiment. In FIG. 2, the flicker extracting means 2 includes storage means 10 for inputting a line lightness value from the integrating means 1, difference means 11 for inputting the output of the integrating means 1 and the output of the storage means 10, storage means 12 for inputting the output of the difference means 11, comparing means 13 for inputting the output of the difference means 11 and the output of the storage means 12, count means 14 for inputting the output of the comparing means 13, and frequency deciding means 15 for inputting the output of the count means 14 and the output of the comparing means 13.

The storage means 10 temporarily stores a line lightness value output from the integrating means 1 and the difference means 11, takes a difference between the line lightness value to be input and the line lightness value obtained one line before which is stored in the storage means 10, and outputs a difference code (positive or negative). The storage means 12 temporarily stores the difference code, and the comparing means 13 compares the difference code output from the difference means 11 with a difference code obtained one line before which is stored in the storage means 12.

The count means 14 increases a count value when the codes are coincident with each other as a result of the comparison of the comparing means 13, and the count means 14 resets the count value to be zero when they are not coincident with each other. The frequency deciding means 15 fetches the count value of the count means 14 and extracts a fluctuation cycle information about a line lightness value from a count value obtained before the reset when the codes are not coincident with each other as a result of the comparison of the comparing means 13.

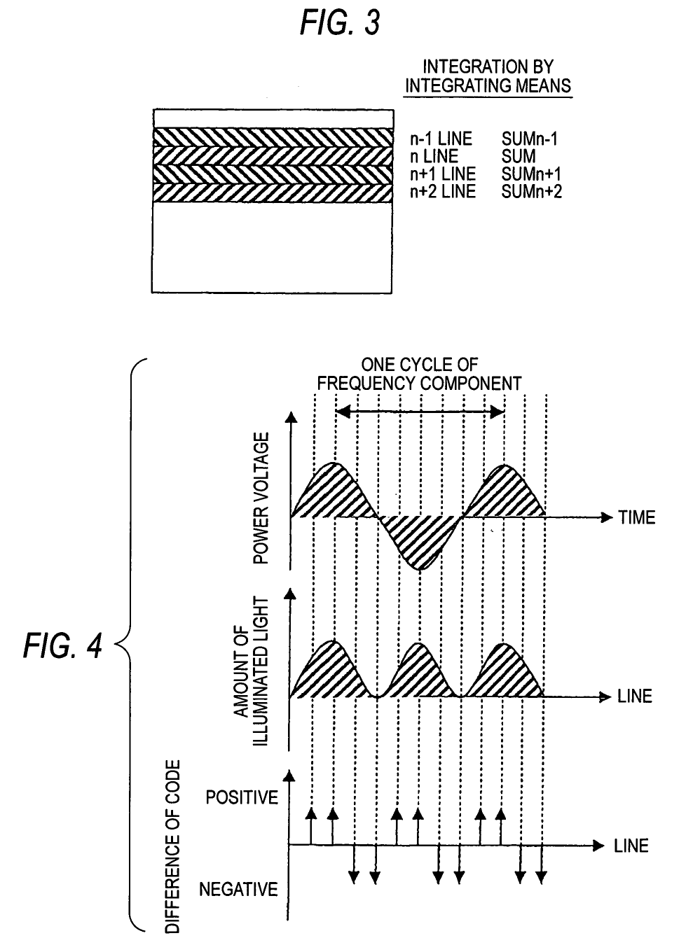

With reference to FIGS. 3 to 5, description will be given to a principle of extracting the fluctuation cycle information about the line lightness value in the flicker detecting apparatus having the structure described above. FIG. 3 is a diagram for explaining a method of integrating a pixel level for each line by the integrating means 1 to obtain a line lightness value, and FIG. 4 is a diagram for explaining a method of obtaining a difference code for each line by the difference means 11.

As shown in FIG. 4, the amount of the illuminated light fluctuates at a double of a power frequency. When a video exposed by using an MOS type imaging unit is sequentially read on a line unit, a fluctuation in the amount of the light appears as a fluctuation in the line lightness in the vertical scanning direction. When the difference in the line lightness value for each line is taken, the code repeats a positive period and a negative period in the same cycle as that of the illuminated light depending on an increase or decrease in the line lightness value.

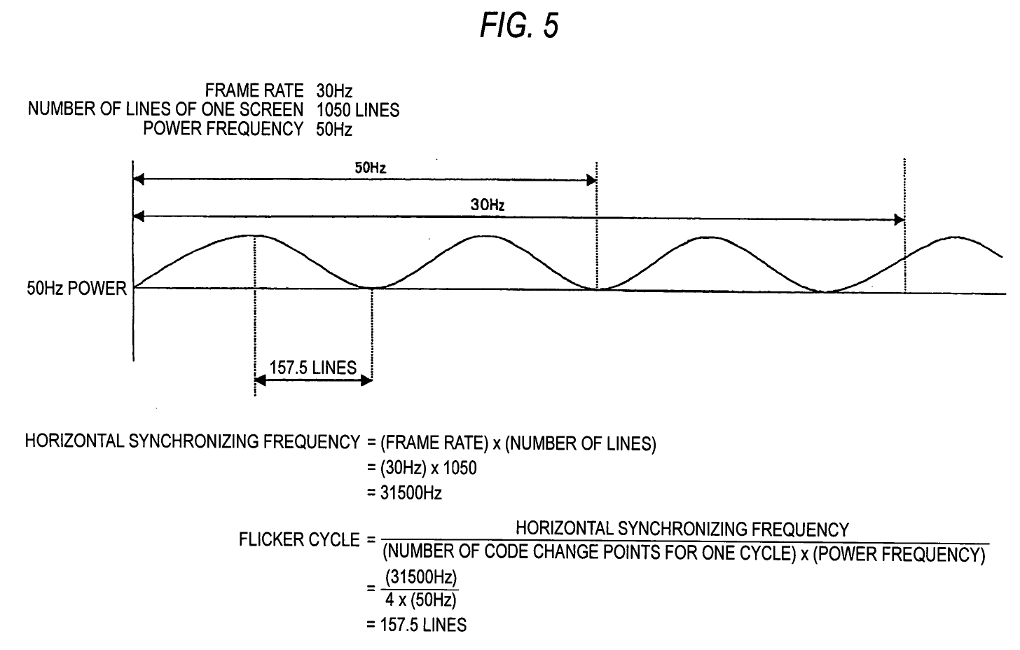

FIG. 5 is a diagram for explaining a method of extracting the fluctuation cycle information about the line lightness value, that is, a flicker cycle from the count value of the difference code when the illuminated light specifically has a power frequency of 50 Hz and a frame rate of 30 Hz.

When the number of lines for one frame is set to be 1050 lines, the horizontal synchronizing frequency of the line is 31500 Hz. Consequently, the number of lines in one power cycle is 31500/50=630. A positive or negative identical code section to be counted by the counter means 14 appears four times in one power cycle. Thus, a cycle for counting is 630/4=157.5. Actually, a count value 157 or 158 is obtained in a timing and indicates a flicker cycle.

Actually, the line lightness value is obtained by superposing the video signal of an object, and the influence of the video signal cannot be sufficiently removed by integration or averaging for each line. Therefore, the accurate count value described above cannot be always obtained. Accordingly, it is necessary to cause the decision of the flicker cycle to have a certain range.

More specifically, the flicker deciding means 3 sets the upper and lower limits of a decision value for each of cases corresponding to the power frequency and frame rate of the illuminated light, for example, and decides that a flicker is present if the output of the flicker extracting means 2 is within a range of a predetermined decision value.

In that case, one frame has a plurality of fluctuation cycles of the line lightness value. If the output of the flicker extracting means 2 is within the range of the predetermined decision value for a constant number of cycles, it is possible to decide that the flicker is present. In case of the example shown in FIG. 5, the fluctuation in the line lightness value appears in six cycles for one frame. For example, therefore, it is assumed to decide that the flicker is present if the output of the flicker extracting means 2 is within the range of the predetermined decision value for two cycles.

Moreover, there is also a possibility that the flicker might be missed for only one frame. Therefore, it is also possible to store the output information of the flicker extracting means 2 for a predetermined number of frames by the flicker deciding means 3 and to decide that the flicker is present if data for a constant number of cycles selected from data in six cycles of each of frames are within the range of the predetermined decision value.

By thus extracting the flicker cycle information from the video signal in one frame, thus, it is not necessary to use the video signals in the frames. Consequently, it is possible to detect a flicker without the influence of the movement of an object, and furthermore, to detect the flicker also when the frame rate and the power frequency of the illuminated light have the proportional relationship. By a method of counting the number of continuations of the difference code in the line lightness value for each line, moreover, it is not necessary to use the conventional discrete Fourier transform. Consequently, it is possible to reduce a circuit scale required for the flicker detecting process.

(Second Embodiment)

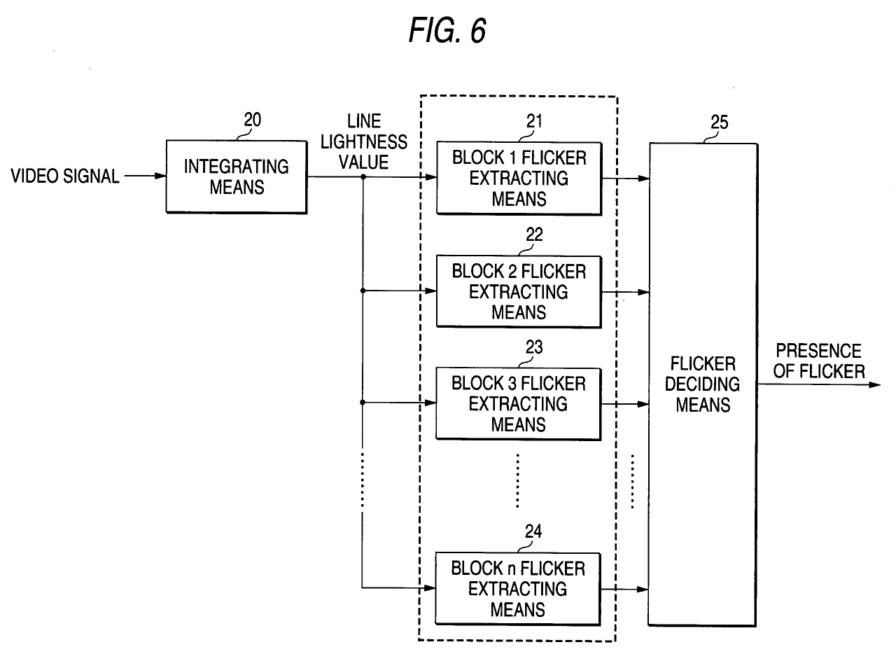

FIG. 6 is a block diagram showing the structure of a flicker detecting apparatus according to a second embodiment of the invention. In FIG. 6, the flicker detecting apparatus comprises integrating means 20, a plurality of flicker extracting means 21 to 24, and flicker deciding means 25.

A video signal for an effective scanning period picked up by an MOS type imaging unit (not shown) is input to the integrating means 20. The integrating means 20 divides one frame into a plurality of blocks and integrates or averages the pixel level of the video signal for the effective scanning period of one frame for each line in each block, and sequentially outputs a line lightness value for each block and each line.

The flicker extracting means 21 to 24 have the same structures as the structure of the flicker extracting means 2 shown in FIG. 2 respectively and are provided corresponding to the blocks, and a line lightness value corresponding to a self block is fetched from the line lightness value for each block and each line which is output from the integrating means 20 and is thus stored, and a fluctuation cycle information about the line lightness value is extracted by the same method as that in the first embodiment from a series of line lightness values for each block.

The flicker deciding means 25 compares a fluctuation cycle information about the line lightness value for each block extracted by the flicker extracting means 21 to 24 with a frequency deciding information respectively, and decides that the flicker is present in the case in which the result of the comparison of a constant number of blocks is within a predetermined frequency range.

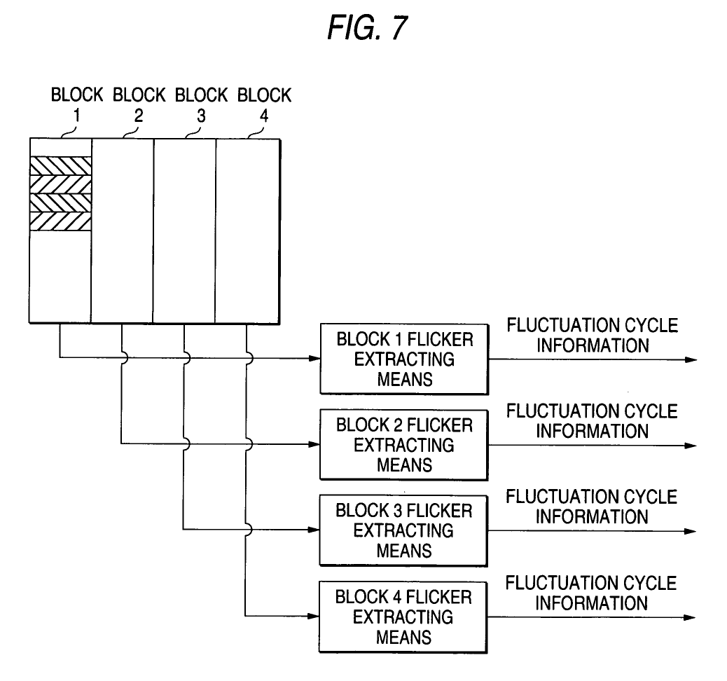

FIG. 7 is a diagram showing an example of a block division in the embodiment. In FIG. 7, one frame is vertically divided into four parts and a line lightness value for each line in each block is output, and the fluctuation cycle information about the line lightness value in the block is extracted by the flicker extracting means corresponding to each block.

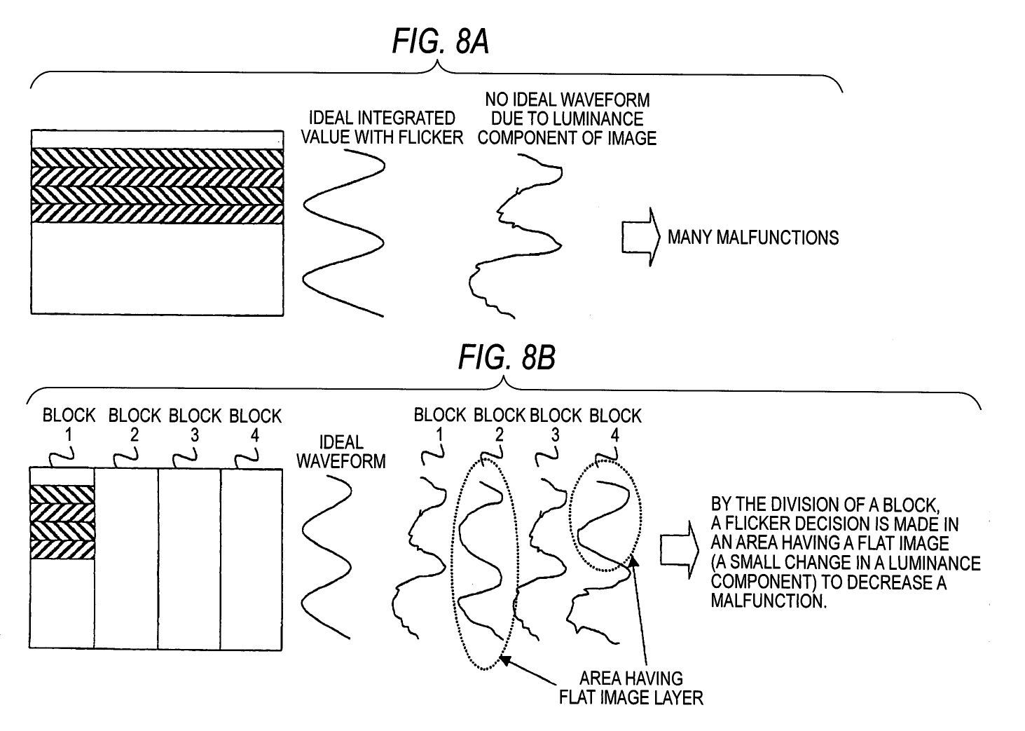

FIGS. 8A and 8B are diagrams for explaining a comparison of the advantage of the embodiment with the first embodiment. FIG. 8A is a diagram showing the advantage of the flicker detecting method according to the first embodiment, in which an actual series of line lightness values is influenced by the video signal to form a distorted waveform. Consequently, the decision of the flicker is hard and the flicker is missed in some cases.

On the other hand, in FIG. 8B, one frame is divided into four blocks as shown in FIG. 7 according to the embodiment. A series of line lightness values for each block is obtained. Although the number of pixels in which the line lightness value is integrated is lessened, therefore, it is possible to obtain a waveform having a comparatively small distortion for a block in which a change in a luminance level is small.

For this reason, there is a high possibility that a block including a waveform having a small distortion and a clear shape can be captured for a series of line lightness values by the execution of the flicker decision for data of each block as described above. Consequently, precision in the flicker decision can be increased, resulting in a reduction in a possibility that the flicker might be missed.

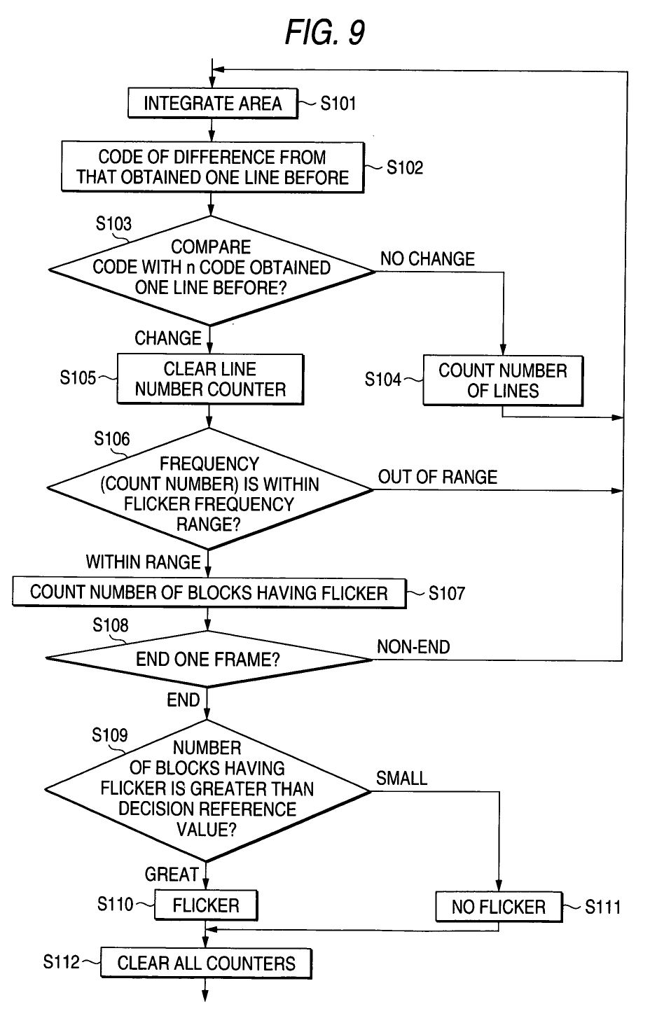

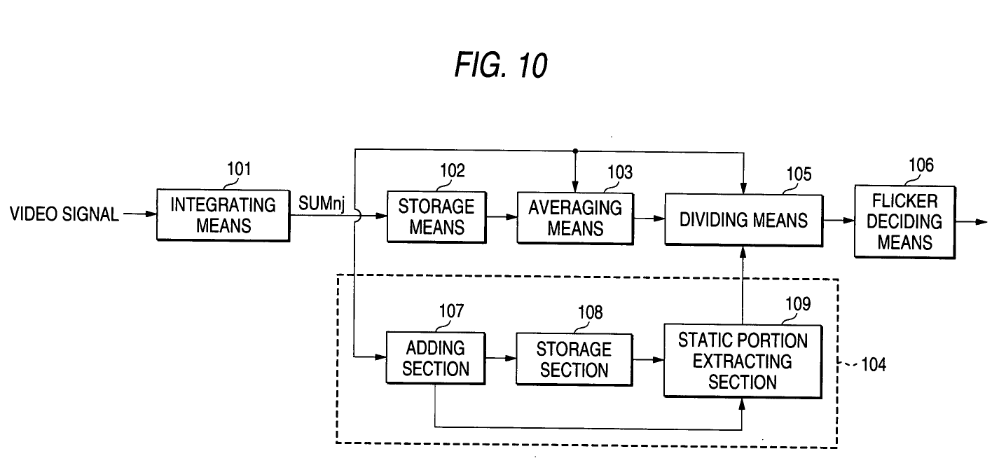

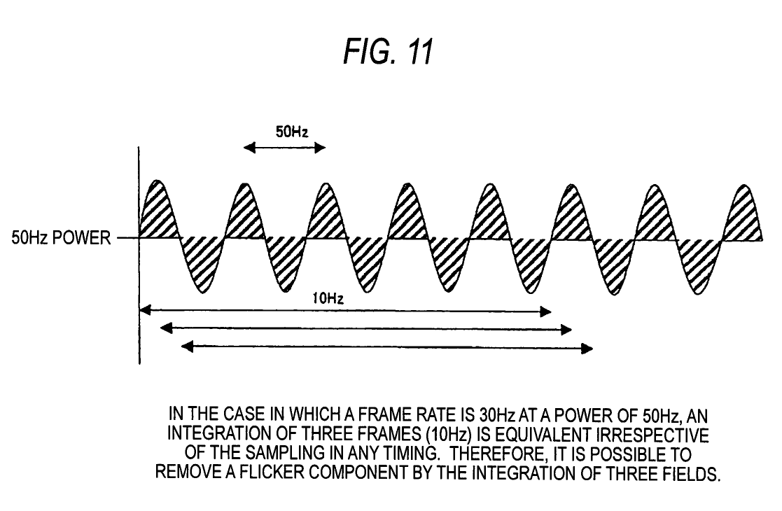

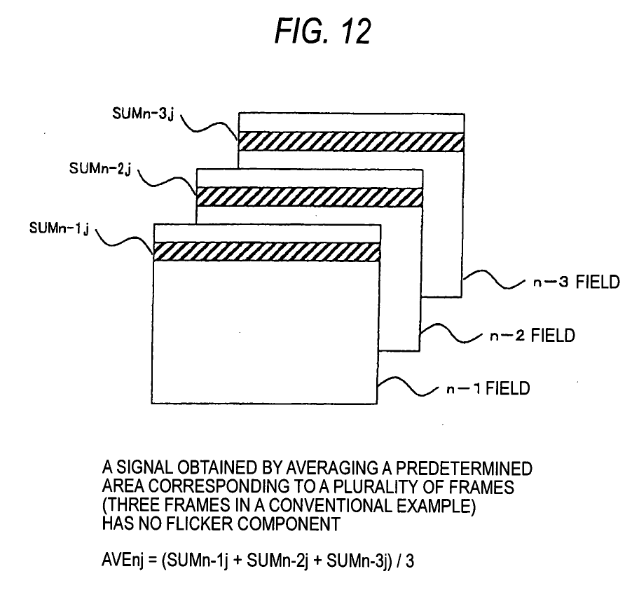

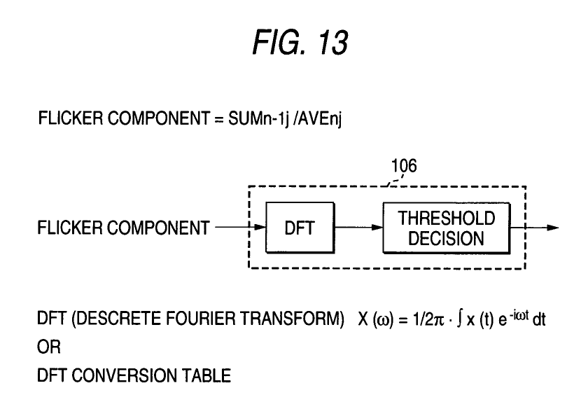

FIG. 9 is a flow chart showing a processing procedure for the flicker detecting method according to the embodiment. In FIG. 9, first of all, a pixel level in each block is integrated for each line to calculate a line lightness value (S101). Next, a difference between the line lightness value and a line lightness value obtained one line before for each line is calculated and a code thereof is fetched (S102).

The code fetched at S102 is compared with a code obtained one line before (S103). If the same code continues, a counter is incremented (S104) and the routine returns to the S101 and proceeds to a next line.

If the codes are different from each other by the code comparison in the S103, a counter value at that time is fetched and the counter is cleared (S105), and the counter value thus fetched is compared with a flicker frequency decision value having a decision range (S106). If the counter value is out of a flicker frequency range as the result of the comparison, the routine returns to the S101 and proceeds to a next line.

If the counter value is within the flicker frequency range as the result of the comparison in the S106, it is counted that the decision of the presence of a flicker is obtained for one block (S107). If the processing does not end by a scanning ending check for one frame (S108), the routine returns to the S101 and proceeds to a next line.

If the processing ends by the scanning ending check for one frame at the S108, the number of blocks counted by obtaining the decision of the presence of a flicker is compared with a predetermined decision reference value (S109). Depending on whether the number of counted blocks is equal to or more than a predetermined decision reference value, it is decided whether the flicker is present (S110) or the flicker is not present (S111), and all the counters are cleared to provide for a next frame and the processing of one frame is ended (S112).

When the presence of the flicker is to be decided, one frame has a plurality of fluctuation cycles of the line lightness value as described in the first embodiment. Therefore, there is at least one fluctuation cycle information about the line lightness value for each block corresponding to a block dividing method. Referring to data on almost (the number of blocks) X (the number of fluctuation cycles of the line lightness value in one frame), consequently, the presence of the flicker is decided. If it is decided that a constant number of flickers are present, it can be finally decided that the flicker is present.

Thus, one frame is divided into a plurality of blocks and the flicker cycle information is extracted from the video signal for each block. Consequently, there is increased a possibility that the flicker cycle information can be extracted from the block in which a change in a suitable luminance level for the detection of the flicker is reduced. Thus, the decision can be carried out with higher precision and there is reduced a possibility that the flicker might be missed.

As described above, according to the invention, the flicker cycle information is extracted from the video signal for one frame. Consequently, it is not necessary to use the video signals for a plurality of frames. Therefore, it is possible to detect a flicker without the influence of the movement of an object. Also in the case in which a frame rate and a power frequency of an illuminated light have a proportional relationship, moreover, it is possible to detect a flicker.

According to the invention, furthermore, one frame is divided into a plurality of blocks and a flicker cycle information is extracted from a video signal for each block. Consequently, there is increased a possibility that the flicker cycle information can be extracted from a block in which a change in a suitable luminance level for the detection of a flicker is small. Thus, it is possible to make a decision with higher precision and there is reduced a possibility that the flicker might be missed.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

What is claimed is:

1. A flicker detecting method comprising the steps of:
calculating a lightness value for each of at least two lines in a frame or a field of a video; and
comparing the lightness value of at least two of said at least two lines.

2. The flicker detecting method according to claim 1, wherein at the calculating step, each of the lightness values of said at least two lines is calculated based on the pixel level of the entire line.

3. The flicker detecting method according to claim 1, wherein at the calculating step, the lightness value for all lines in the frame or the field is calculated.

4. The flicker detecting method according to claim 1, wherein at the comparing step, the lightness values between two adjacent lines of said at least two lines are compared.

5. The flicker detecting method according to claim 1, wherein at the comparing step, the lightness values between all adjacent lines in the frame or the field are compared.

6. The flicker detecting method according to claim 1, further comprising the step of:
extracting a fluctuation cycle from a result of the comparing step.

7. The flicker detecting method according to claim 6, wherein at the extracting step, the fluctuation cycle in a vertical scanning direction of the frame or the field is extracted.

8. The flicker detecting method according to claim 6, wherein at the extracting step, the fluctuation cycle is extracted from differences of the lightness values at the comparing step.

9. The flicker detecting method according to claim 6, wherein the extracting step includes:
taking differences from the result of the comparing step, and
counting a number of continuations of an identical code from the differences.

10. The flicker detecting method according to claim 6, further comprising the step of:
deciding that a flicker is present from a result of the extracting step.

11. The flicker detecting method according to claim 10, wherein at the deciding step, deciding that the flicker is present when the fluctuation cycle is within a predetermined frequency range.

12. The flicker detecting method according to claim 1, wherein the frame or the field is divided into a plurality of blocks and,
wherein at the comparing step, the lightness value of at least two of said at least two lines are compared in each of the plurality of blocks.

13. The flicker detecting method according to claim 12, further comprising the step of:
extracting a fluctuation cycle in each of the plurality of blocks from a result of the comparing step.

14. The flicker detecting method according to claim 13, further comprising the step of:
deciding that a flicker is present when a number of blocks in which the fluctuation cycle is within a predetermined frequency range is within a predetermined value.

15. A flicker detecting apparatus comprising:
calculating means for calculating a lightness value for each of at least two lines in a frame or a field of a video; and
comparing means for comparing the lightness value of at least two of said at least two lines.

16. The flicker detecting apparatus according to claim 15, wherein the calculating means calculates each of the lightness values of said at least two lines based on the pixel level of the entire line.

17. The flicker detecting apparatus according to claim 15, wherein the calculating means calculates the lightness value for all lines in the frame or the field.

18. The flicker detecting apparatus according to claim 15, wherein the comparing means compares the lightness values between two adjacent lines of said at least two lines.

19. The flicker detecting apparatus according to claim 15, wherein the comparing means compares the lightness values between all adjacent lines in the frame or the field.

20. The flicker detecting apparatus according to claim 15, further comprising:
extracting means for extracting a fluctuation cycle from a result of the comparing means.

21. The flicker detecting apparatus according to claim 20, wherein the extracting means extracts the fluctuation cycle in a vertical scanning direction of the frame or the field.

22. The flicker detecting apparatus according to claim 20, wherein the extracting means extracts the fluctuation cycle from differences of the lightness values.

23. The flicker detecting apparatus according to claim 20, wherein the extracting means includes:
taking difference means for taking differences from the result of the comparing means, and
counting means for counting a number of continuations of an identical code from the differences.

24. The flicker detecting apparatus according to claim 20, further comprising:
deciding means for deciding that a flicker is present from a result of the extracting means.

25. The flicker detecting apparatus according to claim 24, wherein the deciding means decides that the flicker is present when the fluctuation cycle is within a predetermined frequency range.

26. The flicker detecting apparatus according to claim 15, wherein the frame or the field is divided into a plurality of blocks and,
wherein the comparing means compares the lightness value of at least two of said at least two lines in each of the plurality of blocks.

27. The flicker detecting apparatus according to claim 26, further comprising:
extracting means for extracting a fluctuation cycle in each of the plurality of blocks from a result of the comparing means.

28. The flicker detecting apparatus according to claim 27, further comprising:
deciding means for deciding that a flicker is present when a number of blocks in which the fluctuation cycle is within a predetermined frequency range is within a predetermined value.
